(19) United States
(12) Patent Application Publication
(10) Pub. No.: US 2009/0162034 A1
(43) Pub. Date: Jun. 25, 2009

(54) INFORMATION RECORDING/REPRODUCING APPARATUS AND METHOD FOR RECORDING/REPRODUCING INFORMATION

(76) Inventors: Tsutomu USUI, Yokohama (JP); Haruhiko Higuchi, Fujisawa (JP)

Correspondence Address: MCDERMOTT WILL & EMERY LLP, 600 13TH STREET, N.W., WASHINGTON, DC, 20005-3096, US

(21) Appl. No.: 12/337,223

(22) Filed: Dec. 17, 2008

(30) Foreign Application Priority Data
Dec. 20, 2007 (JP) 2007-328137

(51) Int. Cl. H04N 7/26

(52) U.S. Cl. 386/124; 386/E05.001

(57) ABSTRACT

A video recording/reproducing apparatus having an HDD to a mobile device using removable media such as a BD. Data can be removed and stored by copying and moving data recorded on the HDD onto these removable media or in the direction opposite thereto. When vibrations occurs on a recording medium inserted into the HDD, DVD drive, and BD drive due to foreign elements, a copy or movement of data tends to fail. To solve the problem, provided is an apparatus or method including a portable power source, a recording unit for recording information on a removable medium and a built-in medium, a dubbing unit for copying or moving data therebetween, and a detector for detecting acceleration, wherein when the acceleration detected by the detector has a predetermined value, the dubbing unit operates between the recording media.

### INCORPORATION BY REFERENCE

The present application claims priority from Japanese application JP2007-328137 filed on Dec. 20, 2007, the content of which is hereby incorporated by reference into this application.

### BACKGROUND OF THE INVENTION

1. Field of the Invention

The present invention relates to an information recording/reproducing apparatus and a method for recording/reproducing information.

2. Description of the Related Art

Japanese Patent Publication No. Hei 11-353783 describes that “provided is a disk recording/reproducing apparatus that prevents false information from being written into, i.e. recorded, due to vibrations during a dubbing operation to a disk”.

Japanese Patent Publication No. 2003-187449 describes such a problem that “provided is an information recording technique which, even when an interruption of recording operation takes place for some reasons in recording information on a plurality of types of recording media, can make the most of the features of a recording medium and can record data on the medium with a good reliability”. It is also described that such a solution is used that “abnormality judging conditions according to the type of the recording medium are changed and record resuming conditions after the interruption of the recording operation are changed”.

### SUMMARY OF THE INVENTION

In recent years, a video camera having mounted thereon an optical disk such as a DVD (Digital Versatile Disc) or a BD (Bluray Disc) as a recording medium of images enters the stage. Further, the video camera expands the market with good retrievability of recorded scenes through a random access as well as good usability such as preventing the overwriting by arbitrarily recording information on an unrecorded part.

On the other hand, a storage capacity of a miniature hard disk drive (HDD) or a flash memory increases. Thereby, a video camera having mounted thereon these hard disks or flash memories as a recording media also enters the stage. Recently, a video camera having mounted thereon a plurality of different recording media such as an optical disk and a hard disk also becomes widely used.

One of the utilizations of the above-described video camera having a plurality of recording media includes a copy (hereinafter, it is called a dubbing operation) or movement of data between a plurality of recording media. Since the video camera is a portable apparatus, an effect of vibrations due to a camera shake or the presence or absence and residual capacity of a power source must be considered in performing the dubbing operation using such a portable apparatus. Further, since a plurality of types, for example, rewritable/unrewritable types or types such as the DVD and the BD are present recently even in the optical disk, the above-described types of the recording media must also be considered in performing the dubbing operation.

On this point, in Japanese Patent Publication No. Hei 11-353783, vibrations are considered and the dubbing operation is controlled in stages according to a speed of vehicle. Further, since in-vehicle devices are mainly covered, the power source is stably supplied basically. Therefore, it is not considered that the dubbing control is changed in consideration of a state of the power source.

Also in Japanese Patent Publication No. 2003-187449, vibrations are considered and it is described that conditions for interrupting the recording operation are changed according to types such as rewritable and unrewritable recording media in the video camera using an optical disk as a recording medium. However, it is not considered that the dubbing control is changed in consideration of a state of the power source.

In both of the Patent Documents, it is not also considered that the dubbing control is changed according to types of the recording media such as the DVD and the BD.

In view of the foregoing, it is an object of the present invention to provide a user-friendly information recording/reproducing apparatus and method for recording/reproducing information.

In the present invention, the above-described problem can be solved, for example, by performing the following embodiments; however, it is not limited to these embodiments.

According to one embodiment of the present invention, there is provided an information recording/reproducing apparatus. The apparatus comprises:
a first recording/reproducing section;
a second recording/reproducing section; and
a portable power source, wherein:
when the power source has a predetermined battery residual capacity and acceleration that is applied to the information recording/reproducing apparatus is lower than a predetermined threshold, a dubbing operation from the first recording/reproducing section to the second recording/ reproducing section is allowed.

According to another embodiment of the present invention, there is provided an information recording/reproducing apparatus. The apparatus comprises:
a first recording/reproducing section;
a second recording/reproducing section; and
an external power source input terminal capable of supplying power from the outside, wherein:
when power is supplied from the external power source input terminal and acceleration that is applied to the information recording/reproducing apparatus is lower than a predetermined threshold, a dubbing operation from the first recording/reproducing section to the second recording/ reproducing section is allowed.

According to yet another embodiment of the present invention, there is provided an information recording/reproducing apparatus. The apparatus comprises:
a first recording/reproducing section; and
a second recording/reproducing section, wherein:
when acceleration that is applied to the information recording/reproducing apparatus is lower than a predetermined threshold, a dubbing operation from the first recording/reproducing section to the second recording/reproducing section is allowed; and
the threshold and a speed of the dubbing operation change depending on a type of the second recording medium.

According to the present invention, the user-friendly information recording/reproducing apparatus and information recording/reproducing method can be provided.

### BRIEF DESCRIPTION OF DRAWINGS

FIG. 1 is a block diagram illustrating a structure example of an information recording/reproducing apparatus of the invention.

FIG. 2 is a flowchart showing a process example according to a first embodiment of the invention.

FIG. 3 is a flowchart showing a process example according to a second embodiment of the invention.

FIG. 4 is a flowchart showing a process example according to a third embodiment of the invention.

FIG. 5 is a flowchart showing a process example according to a fourth embodiment of the invention.

FIG. 6 is a flowchart showing a process example according to a fifth embodiment of the invention.

### DESCRIPTION OF THE EMBODIMENTS

Hereinafter, preferred embodiments of the present invention will be described with reference to the accompanying drawings.

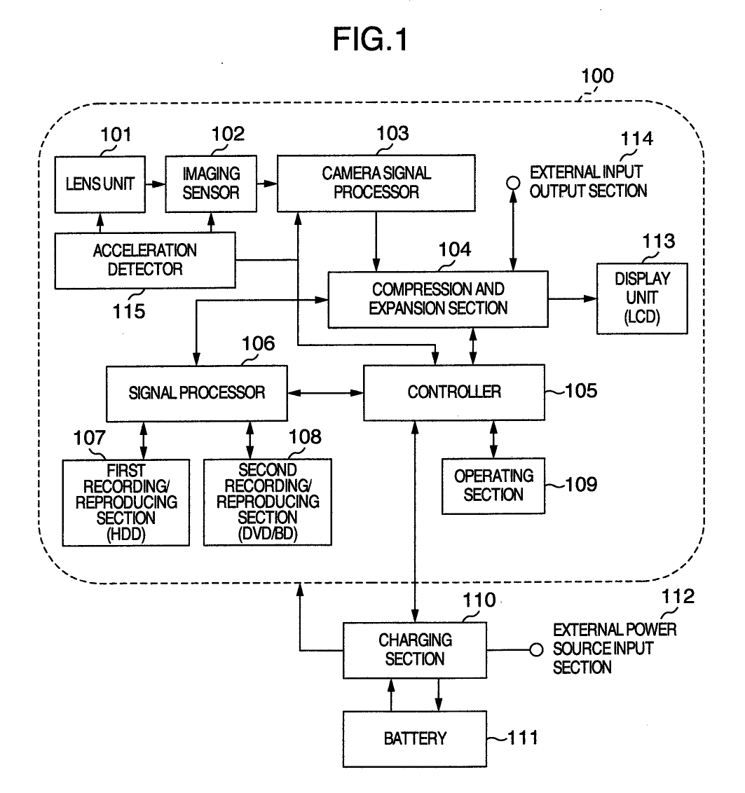

FIG. 1 is a block diagram illustrating a structure example of a camera as one example of an information recording/reproducing apparatus 100.

Reference numeral 101 denotes a lens unit, 102 denotes an imaging sensor, 103 denotes a camera signal processor, 104 denotes a compression and expansion section, 105 denotes a controller, 106 denotes a signal processor, 107 denotes a first recording/reproducing section (assumed to be a hard disk drive (HDD) as one example), 108 denotes a second recording/reproducing section (assumed to be an optical disk medium such as a DVD and a BD as one example), 109 denotes an operating section, 110 denotes a charging section, 111 denotes a battery, 112 denotes an external power source input section, 113 denotes a display unit (assumed to be a liquid crystal display (LCD) as one example), 114 denotes an external input output section, and 115 denotes an acceleration detector.

An operation of the information recording/reproducing apparatus shown in FIG. 1 will be first described. An image of a subject is captured by the imaging sensor 102 via the lens unit 101, the image captured by the imaging sensor is converted into electric signals, and the signals are converted into video signals by the camera signal processor 103.

The video signals are continuously converted into digital video signals by the compression and expansion section 104 that is controlled by the controller 105. Alternatively, by switching the external input and output section 114 to an input, an external input video signal can also be converted into the digital video signal.

Signals that are converted into the digital video signals are recorded in a built-in storage medium such as the DVD or the HDD by the signal processor 106. The DVD is here used as a recording medium and the HDD is used as a built-in storage medium, and further, a BD and an HD-DVD may be used as a recording medium and a flash memory may be used as a built-in storage medium.

The operating section 109 is further operated to control the controller, the video signals that are recorded in the DVD by the signal processor are read, and the recording operation is performed in the HDD. Thereby, the dubbing operation can be performed between media. Similarly, the video signals that are recorded in the HDD are read and the recording operation can be performed in the DVD.

The video signals that are recorded in the recording medium or in the built-in storage medium is expanded by the compression and expansion section to thereby output the expanded signals to the external input output section. At the same time, the signals can be displayed on the display unit 113. In this connection, the display unit is not limited to a liquid crystal display and, for example, an organic EL display may be used as the display unit.

The apparatus 100 further has the external power source input section 112 as a power source section and power can be supplied from the outside, such as an AC power source. The power is supplied from this external power source input section, thereby charging the battery 111 by the charging section 110. By doing so, when the power is supplied by the external power source input section, the apparatus is operated by the external power source. Meanwhile, when the power is not supplied from the external power source, the apparatus can be operated by the power supplied from the battery.

In addition to the control of each principal section of the information recording/reproducing apparatus, for example, a battery residual capacity can be obtained or the power supply from the external power source can be switched by the controller 105. In this connection, this function may be realized by the charging section 110.

The apparatus further has the acceleration detector 115 and the detector 115 detects acceleration applied from the outside of the camera, thereby outputting the detection result to the controller. According to the detection result, the dubbing operation can be controlled between the recording media such as the HDD, the DVD, and the BD. The acceleration is detected, for example, using a gyroscope. In the gyroscope, when the acceleration is applied, an inertia force occurs and therefore, the acceleration can be detected using a value of the inertia force. When the acceleration is detected, another method may be used. The acceleration detector outputs information to the lens unit, the imaging sensor, and the camera signal processor and information used for a camera shake correction control may be used.

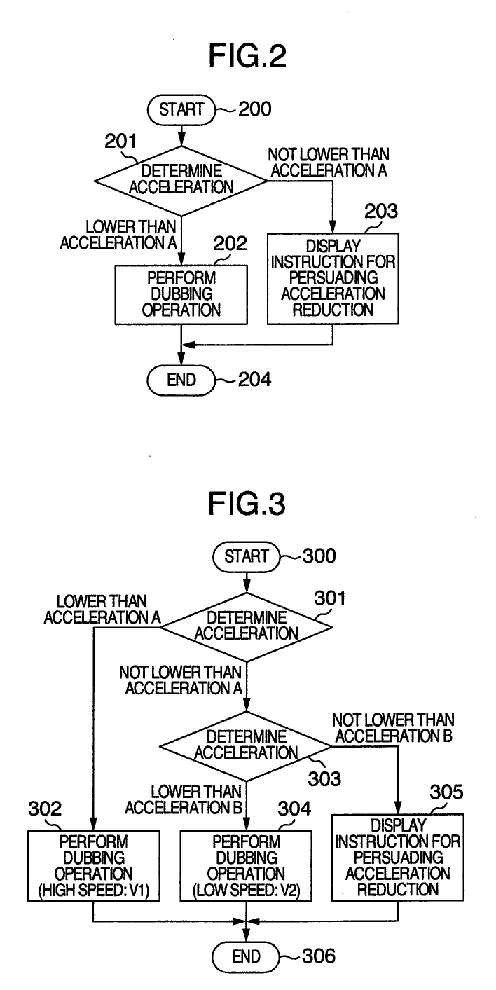

A first embodiment according to the present invention will be described with reference to FIG. 2. When the operating section is operated on this apparatus to perform the dubbing operation, the acceleration is first determined in step 201 as shown in FIG. 2. When it is here determined that the acceleration is lower than a predetermined value A and the dubbing operation can be performed, the dubbing operation is performed in step 202. Meanwhile, when it is determined that the acceleration is not lower than the predetermined value A and the dubbing operation is unsuitable to be performed, an instruction for persuading the acceleration to be reduced is displayed as shown in step 203.

The dubbing operation (copy of data) from the HDD to the DVD will be here described, and a description on the dubbing operation from the DVD to the HDD or also between the recording media such as the flash memory, the BD, and the HD-DVD will also be made in the same manner as that from the HDD to the DVD. Alternatively, a description on the moving operation (movement of data) will also be made in the same manner as that the dubbing operation from the HDD to the DVD.

When the dubbing operation is performed, the detected acceleration is displayed on the LCD so that a user can confirm the acceleration detected at this time and the acceleration necessary for continuing the dubbing operation. The acceleration may be put into the form of a graph in addition to the fact that the acceleration is quantitatively represented. Thereby, user convenience can be improved.

Next, a second embodiment according to the present invention will be described with reference to FIG. 3. When the operating section is operated to perform the dubbing operation in the same manner as in the first embodiment, the acceleration is first determined in step 301 as shown in FIG. 3. When it is here determined that the acceleration is lower than a predetermined value (here, assumed to be A) and the dubbing operation can be performed, the dubbing operation is performed at high speed (assumed to be V1). Meanwhile, when it is determined that the acceleration is not lower than the predetermined value A, the acceleration is further determined in step 303. In the determination of step 303, when it is determined that the acceleration is lower than a predetermined value (here, assumed to be B (A<B)) and the dubbing operation can be performed, the dubbing operation is performed at low speed (assumed to be V2). Meanwhile, when it is determined that the acceleration is not lower than the predetermined value B and its value is insufficient to perform the dubbing operation, an instruction for persuading the acceleration to be reduced is displayed as shown in step 305.

According to the present embodiment, when two thresholds are set in the determination of acceleration, the speed of the dubbing operation can be changed in the case where the acceleration is lower than A and in the case where the acceleration is not lower than A and lower than B, respectively. Thereby, for example, when the acceleration is lower than A, the normal dubbing operation is performed, when the acceleration is not lower than A and lower than B, the speed of the dubbing operation is suppressed. When the acceleration is not lower than B, the dubbing operation is stopped. In the case where the acceleration is not lower than A and lower than B, when the speed of the dubbing operation is suppressed, the rotational speed of the DVD or the traveling speed of the optical pickup can also be suppressed. As a result, the servo control is stabilized in performing the reading/writing operations from/into the DVD and failure of the reading/writing operations can be suppressed.

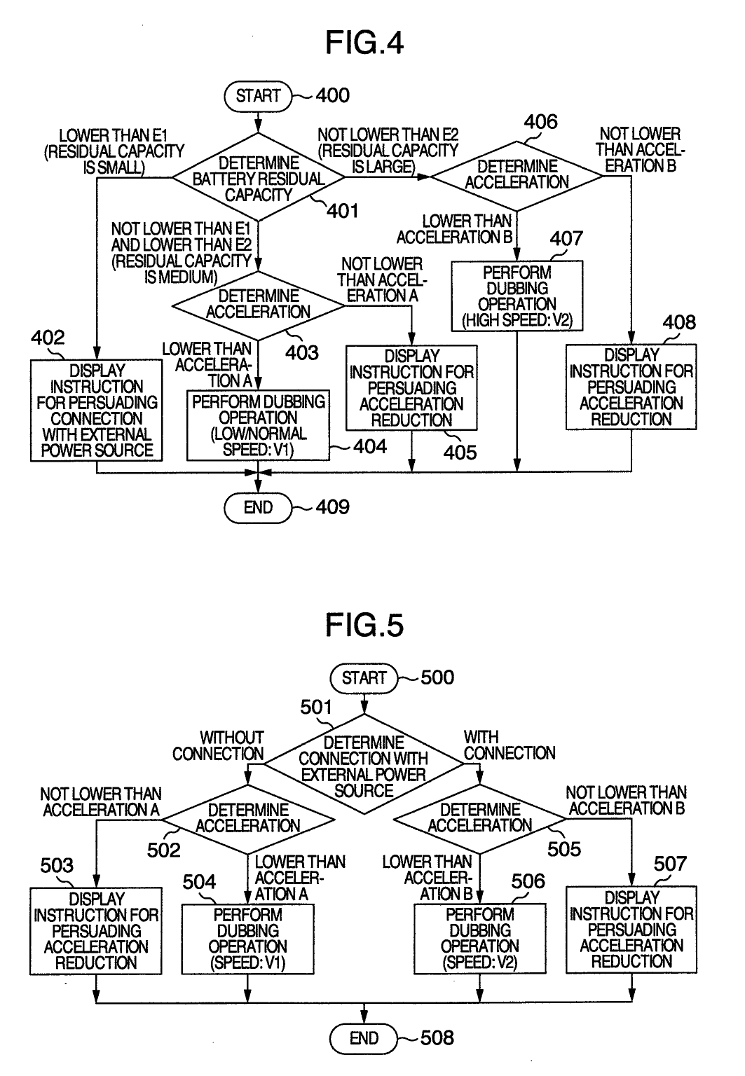

Next, a third embodiment according to the present invention will be described with reference to FIG. 4. When the operating section is operated to perform the dubbing operation in the same manner as in the first embodiment, the battery residual capacity is first determined in step 401 as shown in FIG. 4. When it is here determined that the battery residual capacity is lower than a predetermined value (assumed to be E1), that is, the battery residual capacity is small and its value is insufficient to perform the dubbing operation, an instruction for persuading the charging section to be connected to the external power source is displayed in step 402.

On the other hand, when it is determined that the battery residual capacity is not lower than E1 and lower than E2 (E2 is also a predetermined value, and assumed to be E1<E2), that is, the battery residual capacity is medium and further the dubbing operation can be performed, the acceleration is next determined in step 403. On this occasion, when it is determined that the acceleration is lower than the predetermined value A, the dubbing operation is performed in step 404. Meanwhile, when it is determined that the acceleration is not lower than A, an instruction for persuading the acceleration to be reduced is displayed in step 405. The speed of the dubbing operation is here assumed to be a predetermined speed V1 (assumed to be the low-speed or normal dubbing operation).

When it is determined that the battery residual capacity is not lower than E2, that is, large and further the battery residual capacity is sufficient to perform the dubbing operation, the acceleration is next determined in step 406. On this occasion, when it is determined that the acceleration is lower than the predetermined value B (assumed to be B<A), the dubbing operation is performed in step 407. Meanwhile, when it is determined that the acceleration is not lower than B, an instruction for persuading the acceleration to be reduced is displayed in step 408. The speed of the dubbing operation is here assumed to be a predetermined speed V2 that is faster than V1 (assumed to be the high-speed dubbing operation).

According to the present embodiment, when the battery residual capacity is insufficient to perform the dubbing operation by determining the residual capacity before the determination of the acceleration, the dubbing operation can be prevented from being performed.

When information is dubbed to the optical disk such as the DVD, as the dubbing operation is performed at higher speed, power consumption of laser more increases. To correspond to the above-described fact, as one example in the present embodiment, when the battery residual capacity is medium, the low-speed or normal dubbing operation is performed, whereas when the battery residual capacity is large, the high-speed dubbing operation is performed.

Further, there is the possibility that when vibrations are applied to the camera during the dubbing operation, information fails to be recorded. When the amount of information to be recorded per unit time is considered, loss of information due to the recording failure during the high-speed dubbing operation is larger than that during the low-speed/normal dubbing operation. Therefore, as one example in the present embodiment, the threshold for determining whether of the dubbing operation is assumed to be B<A and further, when the high-speed dubbing operation is performed, the dubbing operation is suspended even in small vibrations.

Next, a fourth embodiment according to the present invention will be described with reference to FIG. 5. When the operating section is operated to perform the dubbing operation in the same manner as in the first embodiment, a connection to an external power source such as an AC power source is first determined in step 501 as shown in FIG. 5. When it is here determined that the connection to the external power source is not performed, the acceleration is determined in step 502. When it is determined that the acceleration is lower than the predetermined value A based on the acceleration determination of step 502, the dubbing operation is performed in step 504 (assumed to be the speed V1). Meanwhile, when it is determined that the acceleration is not lower than A, an instruction for persuading the acceleration to be reduced is displayed in step 503.

On the other hand, when it is determined that the connection to the external power source is performed based on the determination of the connection to the external power source of step 501, the acceleration is determined in step 505. When it is determined that the acceleration is lower than the predetermined value B (assumed to be B<A) based on the acceleration determination of step 505, the dubbing operation is performed in step 506 (assumed to be the speed V2 (V1<V2)). Meanwhile, when it is determined that the acceleration is not lower than B, an instruction for persuading the acceleration to be reduced is displayed in step 507.

From the following reasons also in the present embodiment, the dubbing speed is set to V1<V2 and the thresholds of the acceleration are set to B<A in the same manner as in the third embodiment. According to the present embodiment, the thresholds during the determination of the acceleration and the speed of the dubbing operation can be set individually based on the determination of the connection to the external power source. Since the battery residual capacity need not be considered during the connection to the external power source, the high-speed dubbing operation can be performed as compared with the case of the connection to the battery. Further, when the dubbing operation is performed at higher speed, the servo control during the reading/writing operations from/into the DVD is easy to be more affected by the acceleration. Therefore, the threshold at the time of determining the acceleration is set to be relatively low when performing the high-speed dubbing operation.

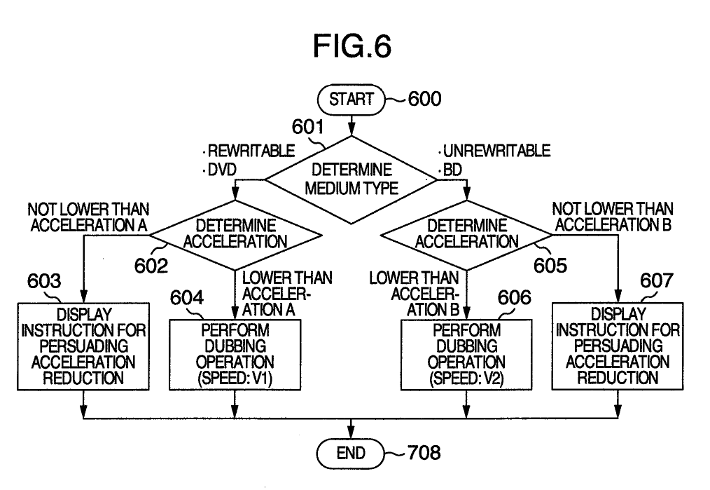

Next, a fifth embodiment according to the present invention will be described with reference to FIG. 6. When the operating section is operated to perform the dubbing operation in the same manner as in the first embodiment, it is determined whether a rewriting operation can be performed to the recording medium in step 601 as shown in FIG. 6. When it is here determined that the rewriting operation can be performed to the recording medium, the acceleration is determined in step 602. When it is determined that the acceleration is lower than the predetermined value A based on the acceleration determination of step 602, the dubbing operation is performed in step 604 (assumed to be the speed V1). When it is determined that the acceleration is not lower than the predetermined value A, an instruction for persuading the acceleration to be reduced is displayed in step 703.

On the other hand, when it is determined that the rewriting operation cannot be performed to the recording medium based on the determination of the recording medium of step 601, the acceleration is determined in step 605. When it is determined that the acceleration is lower than the predetermined value B (assumed to be B<A) based on the acceleration determination of step 605, the dubbing operation is performed in step 606 (assumed to be the speed V2 (V1<V2)). Meanwhile, when it is determined that the acceleration is not lower than the predetermined value B, an instruction for persuading the acceleration to be reduced is displayed in step 607.

Further, a type of the medium to be determined in step 601 may be set to a standard such as the DVD and the BD. When the medium is the DVD, the process goes to step 602. Meanwhile, the medium is the BD, the process goes to step 605.

According to the present embodiment, the thresholds at the time of determining the acceleration can be set individually based on the determination of whether a rewriting operation can be performed to a recording medium as a dubbing destination. Accordingly, when the recording medium is rewritable, the rewriting operation can be performed again even if the dubbing operation fails by any chance. Therefore, as compared with the case where the recording medium is unrewritable, the threshold at the time of determining the acceleration is made high and the dubbing operation can be performed at high speed in an environment with more vibration. In addition, when the threshold at the time of determining the acceleration is made high as described above, the dubbing speed is made low to thereby prevent loss of information. On the contrary, when the threshold at the time of determining the acceleration is made high and further the dubbing speed is also made high, the apparatus can respond to the case where reduction in the processing time is desired to be placed ahead of the prevention of the loss of information.

Further, when using the BD for recording information in the high density, a large amount of information is lost in the failure of the dubbing operation due to vibrations as compared with the DVD. Therefore, when information is recorded on a high-density recording medium such as the BD and the HD-DVD, the threshold at the time of determining the acceleration is made low. Thereby, the loss of information can be prevented, for example, even in the environment with more vibration. Further, when the threshold is made low and further the dubbing speed is also made low, the apparatus can respond to the case where the prevention of the loss of information is desired to be placed ahead of the reduction in the processing time.

As described above, a plurality of embodiments are described, and further, can be performed in arbitrary combination thereof.

Further, descriptions are made by taking the DVD as an example and further, descriptions may be made by taking, as an example, other optical disks such as the BD and the HD-DVD. A combination of the HDD and the recording medium other than the optical disk, for example, the HDD and the semiconductor memory, or the built-in semiconductor memory and the removable semiconductor memory may be used. In this connection, since the affect of reading and writing operations due to external vibrations is large, particularly, to a combination of the HDD and the optical disk, the present embodiment is considered to be effective.

It should be further understood by those skilled in the art that although the foregoing description has been made on embodiments of the invention, the invention is not limited thereto and various changes and modifications may be made without departing from the spirit of the invention and the scope of the appended claims.

1. An information recording/reproducing apparatus for recording or reproducing information, comprising:
an imaging means for photographing video information;
a first recording/reproducing section for recording the video information on a first recording medium or for reproducing the video information from the first recording medium;
a second recording/reproducing section for recording the video information on a second recording medium that is different from the first recording medium or for reproducing the video information from the second recording medium;
an acceleration detector for detecting acceleration that is applied to the information recording/reproducing apparatus; and
a portable power source, wherein:
when the power source has a predetermined battery residual capacity and acceleration that is detected by the acceleration detector is lower than a predetermined threshold, a dubbing operation from the first recording/reproducing section to the second recording/reproducing section is allowed.

2. An information recording/reproducing apparatus for recording or reproducing information, comprising:
an imaging means for photographing video information;
a first recording/reproducing section for recording the video information on a first recording medium or for reproducing the video information from the first recording medium;
a second recording/reproducing section for recording the video information on a second recording medium that is different from the first recording medium or for reproducing the video information from the second recording medium;
an acceleration detector for detecting acceleration that is applied to the information recording/reproducing apparatus; and
an external power source input terminal capable of supplying power from the outside, wherein:
when power is supplied from the external power source input terminal and acceleration that is detected by the acceleration detector is lower than a predetermined threshold, a dubbing operation from the first recording/reproducing section to the second recording/reproducing section is allowed.

3. The information recording/reproducing apparatus according to claim 2, further comprising:
a portable power source, wherein:
even when power is not supplied from the external power source input terminal, the power source has a predetermined battery residual capacity; and
when the power source has a predetermined battery residual capacity and acceleration that is detected by the acceleration detector is lower than a predetermined threshold, a dubbing operation from the first recording/reproducing section to the second recording/reproducing section is allowed.

4. The information recording/reproducing apparatus according to claim 1, wherein:
the threshold and a speed of the dubbing operation change depending on a battery residual capacity of the power source.

5. The information recording/reproducing apparatus according to claim 4, wherein:
when a battery residual capacity of the power source is lower than E1, the dubbing operation is prohibited;
when a battery residual capacity of the power source is not lower than E1 and lower than E2 (E1<E2), the threshold is a threshold A and the dubbing operation is performed at the speed V1; and
when a battery residual capacity of the power source is not lower than E2, the threshold is a threshold B that is lower than the first threshold and the dubbing operation is performed at the speed V2 that is faster than the speed V1.

6. The information recording/reproducing apparatus according to claim 5, further comprising:
a display unit for displaying information, wherein:
when the dubbing operation is prohibited, information for persuading the information recording/reproducing apparatus to be connected to an external power source is displayed on the display unit.

7. The information recording/reproducing apparatus according to claim 5, further comprising:
a display unit for displaying information, wherein:
when the power source has a predetermined battery residual capacity and acceleration that is detected by the acceleration detector is not lower than a predetermined threshold, information for persuading the acceleration to be reduced is displayed on the display unit.

8. An information recording/reproducing apparatus for recording or reproducing information, comprising:
an imaging means for photographing video information;
a first recording/reproducing section for recording the video information on a first recording medium or for reproducing the video information from the first recording medium;
a second recording/reproducing section for recording the video information on a second recording medium that is different from the first recording medium or for reproducing the video information from the second recording medium; and
an acceleration detector for detecting acceleration that is applied to the information recording/reproducing apparatus, wherein:
when acceleration that is detected by the accelerator detector is lower than a predetermined threshold, a dubbing operation from the first recording/reproducing section to the second recording/reproducing section is allowed; and
the threshold and a speed of the dubbing operation change depending on a type of the second recording medium.

9. The information recording/reproducing apparatus according to claim 8, wherein:
when the second recording medium is a rewritable recording medium, the threshold is a threshold A and the dubbing operation is performed at the speed V1; and
when the second recording medium is an unrewritable recording medium, the threshold is a threshold B that is lower than the threshold A and the dubbing operation is performed at the speed V2 that is faster than the speed V1.

10. The information recording/reproducing apparatus according to claim 8, wherein:
when the second recording medium is the DVD, the threshold is a threshold A and the dubbing operation is performed at the speed of V1; and
when the second recording medium is the BD, the threshold is a threshold B that is lower than the threshold A and the dubbing operation is performed at the speed V2 that is faster than the speed V1.

11. An information recording/reproducing method for recording or reproducing information by an information recording/reproducing apparatus comprising:
an imaging means for photographing video information;
a first recording/reproducing section for recording the video information on a first recording medium or for reproducing the video information from the first recording medium;
a second recording/reproducing section for recording the video information on a second recording medium that is different from the first recording medium or for reproducing the video information from the second recording medium; and
a portable power source, the method comprising:
a step for detecting a battery residual capacity of the power source;
a step for detecting acceleration that is applied to the information recording/reproducing apparatus; and
a step for allowing a dubbing operation from the first recording/reproducing section to the second recording/reproducing section when the power source has a predetermined battery residual capacity and the acceleration is lower than a predetermined threshold.

12. An information recording/reproducing method for recording or reproducing information by an information recording/reproducing apparatus comprising:
an imaging means for photographing video information;
a first recording/reproducing section for recording the video information on a first recording medium or for reproducing the video information from the first recording medium;
a second recording/reproducing section for recording the video information on a second recording medium that is different from the first recording medium or for reproducing the video information from the second recording medium; and
an external power source input terminal capable of supplying power from the outside, the method comprising:
a step for detecting the presence or absence of a power supply from the external power source input terminal;
a step for detecting acceleration that is applied to the information recording/reproducing apparatus; and
a step for allowing a dubbing operation from the first recording/reproducing section to the second recording/reproducing section when power is supplied from the external power source input terminal and the acceleration is lower than a predetermined threshold.

13. An information recording/reproducing method for recording or reproducing information by an information recording/reproducing apparatus comprising:
an imaging means for photographing video information;
a first recording/reproducing section for recording the video information on a first recording medium or for reproducing the video information from the first recording medium; and
a second recording/reproducing section for recording the video information on a second recording medium that is different from the first recording medium or for reproducing the video information from the second recording medium, the method comprising:
a step for detecting acceleration that is applied to the information recording/reproducing apparatus;
a step for detecting a type of the second recording medium;
a step for allowing a dubbing operation from the first recording/reproducing section to the second recording/reproducing section when the acceleration is lower than a predetermined threshold; and
a step for changing the threshold and a speed of the dubbing operation depending on a type of the second recording medium.

14. The information recording/reproducing apparatus according to claim 3, wherein:
the threshold and a speed of the dubbing operation change depending on a battery residual capacity of the power source.
